(19) United States
(12) Patent Application Publication
(10) Pub. No.: US 2022/0374569 A1
(43) Pub. Date: Nov. 24, 2022

(54) COMPUTATIONAL DISCOVERY OF MICROSTRUCTURE DESIGNS

(71) Applicant: Massachusetts Institute of Technology, Cambridge, MA (US)

(72) Inventors: Wan Shou, Cambridge, MA (US); Beichen Li, Cambridge, MA (US); Wojciech Matusik, Lexington, MA (US)

(21) Appl. No.: 17/749,361

(22) Filed: May 20, 2022

Related U.S. Application Data
(60) Provisional application No. 63/343,227, filed on May 18, 2022.
(60) Provisional application No. 63/191,007, filed on May 20, 2021.

(51) Int. Cl. G06F 30/23

(52) U.S. Cl. CPC G06F 30/23; G06F 2113/26

(57) ABSTRACT

An approach to designing a structural combination of multiple materials includes determining, using a physical simulator, simulated measurement data for a first plurality of simulation designs. Each simulation design characterizes a structural combination of a plurality of materials. The simulated measurement data for each simulation design provides a simulation of physical qualities of the design. A subset of the simulation designs is selected based on the simulated measurement data for said simulation designs to yield a set of fabrications designs. This set of fabrication designs is provided for fabrication of a set respective physical samples. A set of physical measurements is received for the set of physical samples. Each physical measurement for a physical sample providing measurements a plurality of physical qualities of the sample. The physical simulator is reconfigured using a set of fabrication designs in association with respective physical measurements of physical samples fabricated according to the fabrication designs.

### CROSS-REFERENCES TO RELATED APPLICATIONS

This application claims the benefit of U.S. Provisional Application No. 63/191,007 filed May 20, 2021, and U.S. Provisional Application No. 63/343,227 filed May 18, 2022, both of which are incorporated herein by reference.

### BACKGROUND OF THE INVENTION

This invention relates to designing microstructured composites, which are structural combinations of a number materials.

Recent advances in high-resolution multi-material additive manufacturing enable the creation of high-performance heterogeneous composites through voxel-level microstructure designs. In general, different microstructure designs achieve different material characteristics. Conventional approaches to discovering composite materials with desired material characteristics generally suffer from a limited design space and a weak benchmark that only comprised base materials. More importantly, they fail to address the discrepancies between simulation predictions and experimental measurements.

### SUMMARY OF THE INVENTION

In one aspect, in general, a method for designing a structural combination of multiple materials includes determining, using a physical simulator, simulated measurement data for a first plurality of simulation designs. Each simulation design characterizes a structural combination of a plurality of materials. The simulated measurement data for each simulation design provides a simulation of physical qualities of the design. A subset of the simulation designs is selected based on the simulated measurement data for said simulation designs to yield a set of fabrications designs. This set of fabrication designs is provided for fabrication of a set respective physical samples. A set of physical measurements is received for the set of physical samples. Each physical measurement for a physical sample providing measurements a plurality of physical qualities of the sample. The physical simulator is reconfigured using a set of fabrication designs in association with respective physical measurements of physical samples fabricated according to the fabrication designs.

Aspects may include one or more of the following features.

Selecting the subset of the simulation designs to yield the fabrication designs includes excluding at least one simulation design that is dominated in simulation by at least one other simulation design in the plurality of simulation designs, where a first simulation design is dominated in simulation by a second simulated design when all simulated physical qualities of the first simulated design are worse than the corresponding simulated the physical qualities of the second simulated design;

The output plurality of designs includes only designs that are not dominated in physical measurement by any other design in the plurality of output designs, where a first design is dominated in physical measurement by a second design when all measured physical qualities of the plurality of physical qualities of the first design are worse than the corresponding measured the physical qualities of the second design.

The method further includes determining a plurality of prediction designs, and predicting measurement data for each of the prediction designs.

Predicting measurement data for a prediction design comprises using a neural network to process the prediction design to yield predicted measurement data.

Determining the plurality of prediction designs comprises using an evolutionary procedure to iteratively generate said designs.

Using the neural network comprises using a convolutional neural network to process a spatial specification of material of the design to yield the predicted measurement data.

The method further includes selecting a subset of the prediction designs based on the predicted measurement data for said prediction designs to yield a set of simulation designs.

Selecting the subset of the prediction designs based on the predicted measurement data includes excluding at least one prediction design that is dominated in prediction by at least one other prediction design in the plurality of prediction designs, where a prediction design is dominated in prediction by a second prediction design when all predicted values of the physical qualities of the first prediction design are worse than the corresponding predicted physical qualities of the second prediction.

Each design comprises a spatial array of regions and identification of respective materials in each of the regions of the array.

Determining the simulated measurement data includes performing a finite-element simulation parameterized by physical parameters of the materials.

The physical parameters include at least one of Young's modulus and Poisson's ratio.

Aspects may have one of more of the following advantages.

Aspects described herein advantageously use a combination of several different types of modules, each having a different tradeoff between testing/simulation speed and testing/simulation accuracy. For example, a mechanical tester runs very slowly due to labor-intensive specimen fabrication and testing (˜10⁴ s/sample), but has the advantage of providing ground truth performance values for a fabrication designs. At the opposite end of the spectrum, a predictor is extremely fast (˜10⁵ s/sample) but yields relatively inaccurate results. In between, a simulator is reasonably fast (˜1 s/sample) given its moderate complexity and delivers intermediate accuracy. In general, the faster modules act as surrogate models, conducting multi-objective structural optimization and proposing microstructure designs on the Pareto front to slower modules. The slower modules are more accurate and are used to validate the performance of designs proposed by faster modules and use them as additional training data to improve the accuracy of the faster modules. As the faster modules become increasingly accurate throughout the process, they are able to propose higher quality designs to the slower modules.

Overall, the nested-loop design of the system advantageously improves sample efficiency in discovering microstructure designs with optimal strength-toughness trade-offs. The inner loop between the simulator and the predictor reduces the number of numerical simulations for finding the simulator's Pareto front by an order of magnitude compared with conventional structural optimization algorithms. The outer loop between the mechanical tester and the simulator simultaneously closes the gap between simulation results and mechanical testing results and discovers experimentally verified Pareto-optimal microstructure designs based on only a few dozen physical measurements. It is noted that, in some examples, this is advantageously accomplished with a physics-based simulator that does not incorporate sophisticated or advanced modeling of material inelasticity or fracture. Despite the limited modeling capability, the simulator autonomously learns to match the behavior of Pareto-optimal microstructures with physical experiments.

Other features and advantages of the invention are apparent from the following description, and from the claims.

### BRIEF DESCRIPTION OF THE DRAWINGS

FIG. 1 is a microstructure design discovery system.

FIG. 2 is a microstructure design.

FIG. 3 is a schematic block diagram of the outer loop of the microstructure design discovery system.

FIG. 4 is a schematic block diagram of the inner loop of the microstructure design discovery system.

### DETAILED DESCRIPTION

### 1 Overview

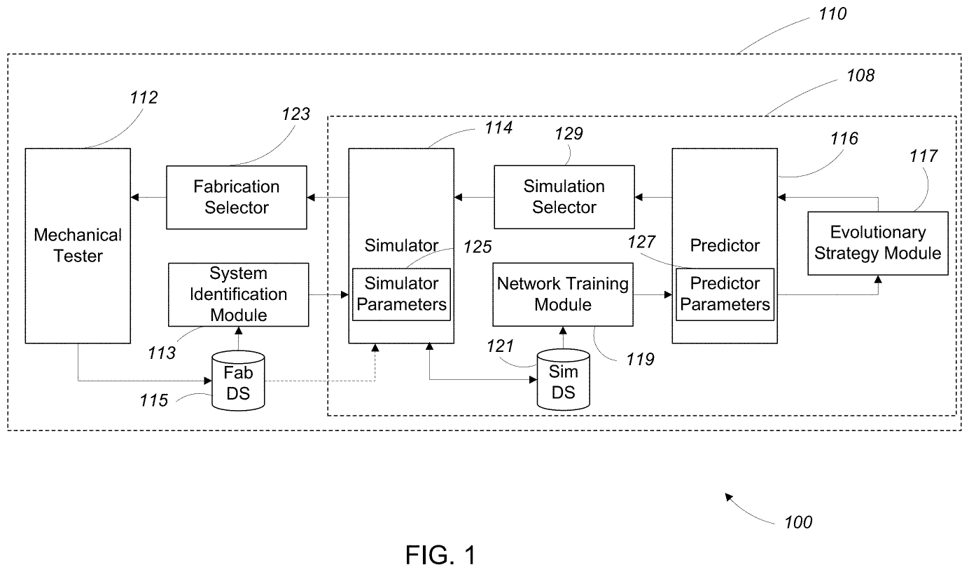

Referring to FIG. 1, a microstructure design discovery system 100 is configured to efficiently and automatically discover microstructure designs that result in composite materials with optimal tradeoffs between multiple qualities, in particular between strength and toughness, without requiring expert-knowledge and without requiring exhaustive physical testing.

### 1.1 Motivating Problem

Before continuing with the details of the microstructure design discovery system 100, a brief overview of the motivating problem is provided. Very generally, microstructured composites are composites formed using techniques such as additive manufacturing, which allow different materials to be spatially enabling designs that were previously difficult or impossible to physically realize. It should be appreciated that if materials are selected for different regions there is a combinatorial space of designs that may be chosen, and each such design may have different qualities.

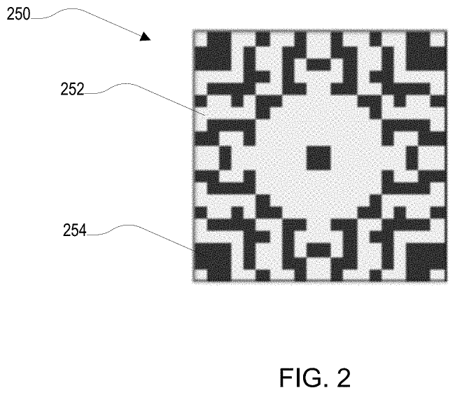

In some examples, while the material may be chosen at a relatively fine resolution for fabrication, a basic structural unit of a microstructured composite that spans a larger region is referred to as a “microstructure design.” One example of a microstructure design 250 is shown in FIG. 2. In some examples, a microstructure design is represented as an arrangement of two or more base materials in a grid (e.g., a 20×20 regular grid). For example, the microstructure design 250 includes an arrangement of a first base material 252 (represented as black squares) and a second base material 254 (represented as white squares). The microstructure design can be repeatedly fabricated using a 3D printing process to form an object. In the examples described herein, the microstructure designs represent a combination of two acrylic-based photopolymers, one rigid and one soft, that contrast in stiffness and ductility. However, it should be understood that the approaches are applicable to more than two materials, and to other specifications of designs than repetitions of two- or three-dimensional microstructure designs

One goal of microstructure design discovery systems is to discover microstructure designs that yield composite materials with desired material qualities, such as material strength and material toughness. Doing so can be challenging because, in order to be tough, a microstructure design preferably yields a composite material that is ductile enough to tolerate long cracks and absorb more energy before fracturing. Although a few suitable microstructure designs have been discovered through trial-and-error approaches or biomimicry, conventionally, there has been no systematic way to efficiently identify microstructure designs to achieve composite materials with desired material qualities.

While computational methods (e.g., structural optimization) allow for efficient exploration of optimal designs inside a parameterized design space with the help of numerical simulation, reliable computational explorations require simulation models to accurately match the corresponding experimental measurements over the entire design space. This is a challenging task for toughness prediction as current approaches to simulation— despite harnessing advanced fracture theories—are unable to fully model the fracture of structured materials. Moreover, the computational process for discovering microstructure designs that are both tough and strong is challenging, since their conflicting nature dictates that there is not a single best solution.

In the process of optimizing designs that trade off multiple qualities, an approach used in embodiments described below is to identify a “Pareto front” of designs. Generally, a design is on the Pareto front if these is no other design that improves on any one of the qualities without degrading another one of the properties. Another way of expressing this property is that a design is not on the Pareto front if it is “dominated” by another design, where a first design is dominated by a second design if the second design is better in at least one quality that the first design and no worse in each of the other qualities. When a discrete set of designs have been evaluated, certain designs can be excluded as being dominated by another of the designs, and an empirical front can be defined by the remaining designs. A goal is for the remaining designs to be on or as close as possible to the Pareto front.

To obtain the entire Pareto front (or at least a simulated Pareto front), available structural optimization algorithms may execute many single-objective optimization routines or rely on evolutionary strategies. Both such approaches incur a large number of simulations. Therefore, finding Pareto-optimal designs using these approaches imposes contradictory demands on the simulator: the simulator should model all physical details to be accurate, but it must also run extremely fast to reduce computational cost. Such simulators have to undergo careful design by field experts, which is normally unrealistic especially for microstructure designs with complicated geometries and abundant material interfaces.

As such, the system described in detail below identifies microstructure designs that lie on or near a simulated Pareto front while significantly reducing the need for computationally expensive simulations and/or fabrication and physical testing.

### 2 Microstructure Design Discovery System

Referring again to FIG. 1, the system 100 relies on both physical fabrication and measurement, as well as computational approaches that make use of relatively limited amounts of physical measurements to propose designs for fabrication and measurement in order to arrive at a set of designs that are at or near the Pareto boundary that trades of multiple different qualities.

The overall physical and computational process uses a nested loop to identify microstructure designs that lie on or near a simulated Pareto front. The system 100 implements an inner loop 108 and an outer loop 110. Very generally, the inner loop uses a finite element method (FEM)-based simulator 114 (i.e., a parameterized physical simulator) and a convolutional neural network (CNN)-based predictor 116 (i.e., parameterized non-linear function) to generate a simulation dataset 121 that includes tuples of simulated microstructure designs (referred to as “validated designs” or “simulation validated designs”) and corresponding simulated qualities (e.g., simulated toughness and simulated strength). To the extent that the parameters of the simulator yield a simulation that matches the physical process of fabrication and measurement, these validated designs can be used identify designs on the Pareto front. Of course, there is always some degree of mismatch of the simulator and the physical system, and therefore the outer loop seeks to refine the simulator to better match the physical system, and in particular, to provide a better match for designs near the Pareto boundary (e.g., possibly at the expense of matching the physical system less accurately for sub-optimal designs that are far away from the Pareto boundary).

The outer loop 110 includes a fabrication proposal selector 123 and a mechanical tester 112. The fabrication proposal selector 123 processes the simulation dataset 121 to identify a number of fabrication designs, where each fabrication design is a validated design from the simulation dataset 121 with simulated qualities that place it on or near the simulated Pareto front. Generally, the goal of the proposal selector is to exclude sub-optimal designs that are dominated by some other design and/or to select designs are distributed on the Pareto front or are expected to provide designs that maximally extend the physically measured front.

The fabrication designs are fabricated (e.g., using additive manufacturing) to yield respective fabricated objects, which may be referred to as physical samples of the designs.

The mechanical tester 112 conducts physical measurements on each of the physical samples, yielding measured qualities (e.g., measured toughness and measured strength). The fabrication designs for the fabricated objects and the measured qualities are stored in a fabrication dataset 115.

The association of designs and corresponding measured qualities forms a training set that is used to determine simulator parameters 125 of the simulator 114. As more physical samples are measured, the increased training data is used to improve the match of the simulator and the physical process, thereby improving the process of proposing new designs to fabricate and measure.

The inner loop 108 and the outer loop 110 execute in an alternating fashion, causing the simulator parameters 125 to repeatedly update and converge such that simulated qualities generated by the simulator 114 for a given microstructure design converge to the measured qualities for an object fabricated according to the same microstructure design (at least that the simulator's Pareto front).

### 2.1 Inner Loop

In a preferred embodiment, the inner loop 108 is configured to explore the maximal simulated performance range of microstructured composites (i.e., the simulated performance gamut) to find designs on the simulation Pareto front. The inner loop 108 employs a neural network-based predictor 116 as a surrogate model to guide the optimization process. A structure of the predictor uses a convolutional neural network (CNN) to map from the microarray two- or three-dimensional grid to the predicted properties of that grid. One CNN with a separate output (e.g., output “channel”) for each quality, or separate CNNs with one output each for each of the qualities, can be used. In examples described below, one CNN produces the predicted toughness and another CNN produces the predicted strength.

Generally, evaluating a design with the predictor requires substantially fewer computational resources (e.g., total number of executed instructions, computation time) than evaluating that design using the simulator. Therefore, while in general the predictor may not yield as accurate a prediction of the qualities of the design as the simulator, the ability to consider a vastly greater number of alternative designs from which a small number are validated by simulation provides an overall increase in efficiency.

Initially, for example, after the parameters of the simulator are initially determined using a set of measured physical samples or the parameters are subsequently updated, the simulation dataset 121 is populated with 10 random (simulation) validated designs and their corresponding simulated qualities. The inner loop 108 repeats the following steps for many (e.g., 500) iterations. First, two neural networks (not shown) included in the predictor 116, one for Young's modulus and one for toughness, are trained (i.e., the predictor parameters 127 are determined) by a network training module 119 using the validated designs and corresponding simulated qualities of all microstructures currently in the simulation dataset 121.

Next, an evolutionary multi-objective optimization algorithm 117 (e.g., a modified NSGA-II algorithm) iteratively interacts with the predictor 116 to identify a set of prediction designs that have been evaluated and have corresponding predicted qualities.

Together, the set of prediction designs characterize a predicted Pareto front and a subset of the designs are on that front (i.e., as not being dominated by any other of the prediction designs).

The predictor 116 provides the prediction designs to a simulation selector 129, which selects simulation designs including a subset (e.g., 10) of the prediction designs that are

Pareto optimal and provides the selected simulation designs to the simulator 114 for validation. For example, the simulation selector identifies a subset of designs that are both on the predicted Pareto front, and are spaced along the front.

The simulator 114 validates the simulation designs provided by the simulation selector according to the current simulator parameters 125 to generate validated designs and corresponding simulated qualities (e.g., simulated toughness and simulated strength), which are stored in the simulation dataset 121. The augmented simulation dataset 121 is used as training data in the next iteration of the inner loop 108. This process permits the predictor to better match the simulator, particularly near the simulated Pareto front, thereby enabling the predictor to propose better designs for further simulation.

In early iterations, the predictor 114 may be quite inaccurate due to limited training data in the simulation dataset 121. The prediction designs are particularly inaccurate in early iterations since they are far away from the microstructures initially in the simulation dataset 121. Nonetheless, as the inner loop 108 iterates, the predictor 116 becomes more accurate by virtue of accumulating training data from the simulator 114.

### 2.1.1 Simulator

In this embodiment, the simulator 114 is a finite element method (FEM) simulator configured with simplified specimen geometry and material modeling parameters. For example, the FEM grid comprises three types of elements: soft, rigid and interface elements. To simulate mechanical testing of a microstructured composite, each of the three types of elements is characterized by three essential material parameters: Young's modulus, Poisson's ratio and maximal strain energy density (the energy density beyond which an element fails and becomes void). A high-level global damping coefficient is added to capture energy dissipation and suppress numerical oscillations, which results in the simulator 114 having a total of 10 exposed parameters.

In general, no prerequisite knowledge of microstructured composites is assumed, so the exposed parameters are initially optimized to match experimental measurements of base materials, namely, homogeneous composites fabricated with soft, rigid, and interface materials, respectively. With a customized high-performance explicit solver for dynamic finite-element analysis, it takes around 0.015 s for every Young's modulus evaluation and 0.2 s for toughness at maximum throughput.

In some examples, the simulator has a pair of finite element method (FEM)-based virtual testers, which predict Young's modulus, toughness, and non-linear stress-strain response given a microstructure pattern. The Neo-Hookean material model is used for all three base materials (VW+, TB+, and interface material) in a 2D setting. The FEM grids represent simplified geometries of manufactured specimens. To model the interfaces between the rigid and soft materials, microstructure units in the FEM grids are upsampled by two times, and elements located at interfaces are assigned with the interface material. Dirichlet boundary conditions are enforced on displacements in the pulling direction. An explicit solver is used for time integration as it is usually preferred for dynamic simulations and it is simple to implement. Material viscosity is modeled using numerical damping and controlled by a global damping coefficient. For toughness, crack initiation and propagation is modeled by thresholding the strain energy density of each element as derived from the Neo-Hookean model, where the element is removed upon exceeding a material-specific strain energy density threshold. Simulation stops when the gauge stress drops below 20% of the ultimate strength, and toughness is calculated using the area beneath the stress-strain curve. For Young's modulus, a small constant strain is applied, and the grid is allowed to converge to an equilibrium within a fixed number of timesteps. Young's modulus is then obtained from the measured gauge stress.

### 2.1.2 Predictor

As introduced above, in some examples, the predictor contains a pair of residual CNNs—one for toughness and another for strength. In some examples, both networks are instantiated from the same architecture template, but the network for toughness is much larger. This allows for greater learning capacity to capture the complex mapping from microstructure designs to toughness. In each iteration of the inner loop 108, the networks are trained on the data in the simulation dataset 121.

As introduced above, generation of the prediction designs that are evaluated using the predictor uses an evolutionary strategy. In some examples, the evolutionary strategy module 117 uses a modified NSGA-II algorithm to propose prediction designs that are Pareto-optimal designs that likely expand the hypervolume of the current gamut.

In some examples, the modified NSGA-II algorithm of the evolutionary strategy module 117 within has a custom mutation operator and an additional hash-table-based deduplication mechanism. The custom mutation operator substitutes the original mutation and crossover operators in offspring generation. It changes a microstructure pattern at varied scales probabilistically, including flipping a single pixel, drawing a rasterized line, or overwriting a rectangular area of pixels. Symmetry and structure constraints are subsequently enforced on the mutated pattern. The hash-table-based deduplication mechanism prevents microstructure designs from being added to the next generation if they have already been discovered and is a faster alternative to exhaustive match in existing patterns. The discovered microstructures are stored in a global hash table, while each individual run of the modified NSGA-II algorithm uses a separate hash table.

### 2.2 Outer Loop

Generally, the outer loop 110 uses a similar proposal-validation workflow to that used by the inner loop 108. In the outer loop 110, the simulator 114 serves as a surrogate model for the mechanical tester 112 to search for experimental Pareto-optimal microstructure designs with high measure of quality.

In an iteration of the outer loop 100, the simulator 114 provides the simulation dataset 121 to the fabrication selector 123. The fabrication selector 123 processes the simulation dataset to identify a subset (e.g., 8) of the simulation designs as fabrication designs. In some examples, the fabrication designs are Pareto-optimal for the current simulator 114 (i.e., the simulator as currently parameterized). The fabrication designs are used to fabricate specimens and the mechanical tester 112 mechanically tests the actual performance of the specimens. The results of the mechanical tests include tuples of fabricated designs and measured qualities, which are added to the fabrication dataset 115. In some examples, the fabrication dataset 115 may include other, random design and quality tuples for regulation purposes.

Because the simulator 114 generally does not incorporate sophisticated constitutive models or advanced fracture mechanics, the simulated qualities of the early validated designs in the simulation dataset 121 may deviate significantly from the measured qualities of the same designs. For example, in the early stages, the simulator 114 may overestimate the performance of microstructure designs on its Pareto front since the optimization algorithm tries to exploit the discrepancies between simulation and reality. Thus, the experimental Pareto front of the fabricated designs may be much smaller than the simulation Pareto front.

To close the gap between simulation and reality, the outer loop 110 improves the accuracy of the simulator by updating the simulator parameters 125 using a system identification module 113, where the exposed parameters of the simulator 114 are optimized to match simulation outputs with physical measurements for fabricated designs. Over several iterations of the outer loop 110, the gap between simulation and reality is reduced.

In some examples, rather than determining the simulator parameters 125 using physical measurements of base materials directly, the system identification module 113 determines simulator parameters that holistically match the properties of a diverse set of microstructure designs. In some examples, different weights are assigned to fabricated designs to prioritize matches for near-Pareto-optimal designs so that the simulator 114 generalizes better to other designs with desirable performance.

### 2.2.1 Fabrication Selector

In each iteration of the outer loop 110, several microstructure designs near the simulation Pareto front are selected for physical validation by the fabrication selector 123. In some examples, the fabrication selector's selection algorithm has two stages.

First, to identify microstructure designs that are sufficiently close to the Pareto front, each microstructure is associated with a rank induced by Pareto dominance. The 1st rank comprises microstructure designs on the Pareto front of the whole gamut, and the i-th rank contains microstructure designs on the Pareto front of a partial gamut where those in higher ranks are excluded. Then, a microstructure design is qualified as a selection candidate if the following three criteria re satisfied: (1) it is in the 3rd rank or higher; (2) its simulated performance trade-off is better than the actual performance trade-off of homogeneous composites; (3) its toughness is higher than the microstructure with the largest Young's modulus in the gamut.

Second, 8 (or another suitable number) microstructure designs (“fabrication designs”) are chosen from the candidates to cover a wide range of mechanical performance and improve the diversity among discovered microstructure designs. To that end, the candidate microstructure designs are divided into 8 radial bins according to their normalized mechanical performance.

Then, a combinatorial optimization problem is solved, where one microstructure is chosen in each bin such that the selected microstructures maximally distinguished from discovered ones and from each other. In some examples, the optimization problem is addressed using a beam search algorithm that finds an approximated best solution in a few seconds.

### 2.2.2 Mechanical Tester

In some examples, the mechanical tester 112 first fabricates specimens (physical samples). Then the mechanical tester 112 tests the specimens on a universal testing machine (e.g., an Instron 5984 universal testing machine with a maximum load of 150 kN). Tensile tests for Young's modulus measurements are conducted according to ASTM D638. Four specimens a tested for each composite and the results are averaged. Tensile tests for toughness were performed by pulling the specimen at a rate of 2 mm/min. Data acquisition stopped once a crack formed and propagated entirely through the specimen. Because crack propagation in microstructured composites is nonlinear, the toughness is defined as the energy absorbed and dissipated per unit volume; namely, the area under the stress-strain curve. At least four specimens retested for each composite, where at least three specimens that manifested the most common and consistent fracture behaviors are considered valid. These valid toughness measurements are averaged, from which a representative stress-strain curve is selected. The same procedure is followed when testing homogeneous composites for consistency.

### 2.2.3 System Identification Module

In general, the simulated behavior of a microstructure is contingent on several tunable parameters in the simulator 114, including Young's moduli, Poisson's ratios, and strain energy density thresholds of the base materials, and a global damping coefficient. These parameters are optimized in the system identification module 113 for a close match between the simulation output and the physical measurements. For Young's modulus, the mean relative prediction error is minimized over a collection of composites, referred to as the system identification dataset. For toughness, the minimization objective is a combination of mean relative prediction errors on both the toughness value and the stress-strain curve, where the relative error of the curve is defined as the area between simulated and experimental stress-strain curves divided by experimental toughness. To fully utilize the modeling capabilities of the virtual testers, keep parameter values are separately maintained between Young's modulus and toughness simulation. Furthermore, microstructures in the dataset are weighted to reflect priority in system identification. First, microstructures closer to the experimental Pareto front have larger weights since the system mainly focus on near-Pareto-optimal designs. Second, to alleviate possible bias from an uneven performance distribution in the dataset, weight penalties are inflicted upon clusters of microstructures whose physical measurements are too close to one another. Batch Bayesian optimization (BO) is used to solve the minimization problem due to its excellent data efficiency and compatibility with batch simulation mechanisms. The Bayesian optimization algorithm is repeated several (e.g., 5) times using different random seeds, after which the best solution is selected.

### 2.3 Algorithm Overview

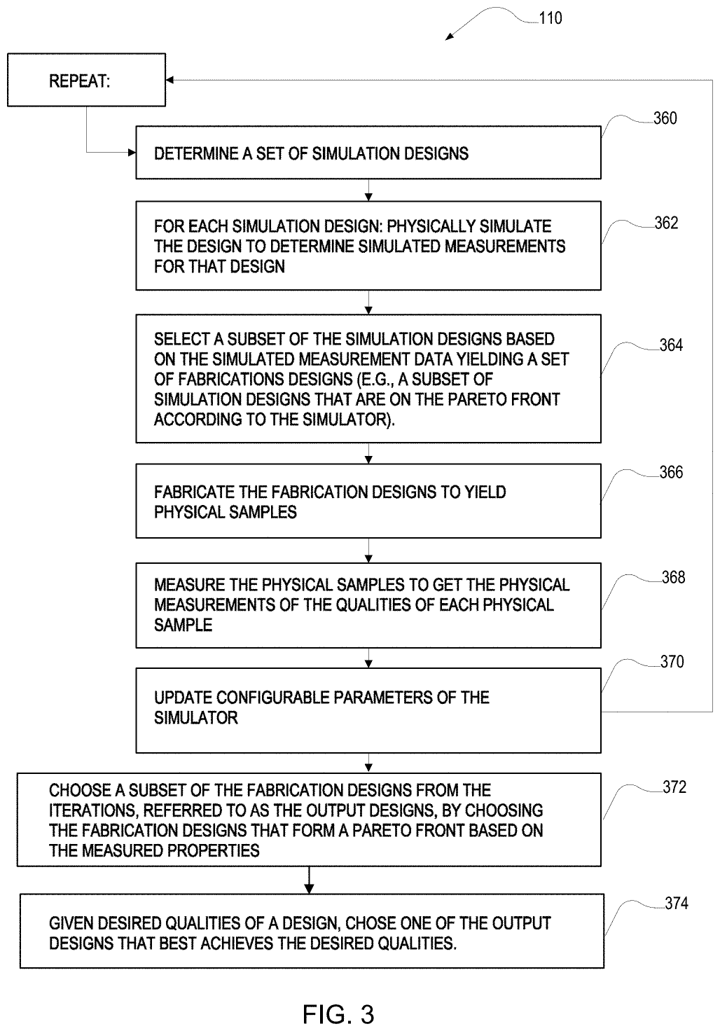

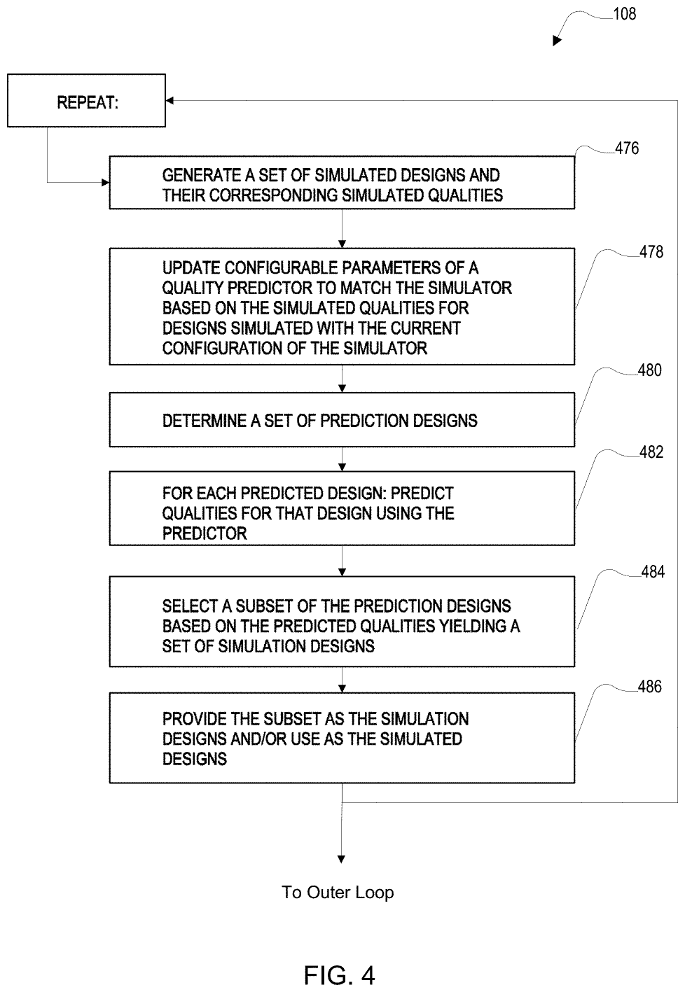

Referring to FIGS. 3 and 4, an overview of the above-described steps performed by the system 100 is presented. In particular, FIG. 3 presents the steps performed by the outer loop 110 of the system 100 and FIG. 4 presents the steps performed by the inner loop 108 of the system 100.

### 2.3.1 Outer Loop

Referring to FIG. 3 alone, the outer loop 100 repeatedly performs a number of steps beginning with a first step 360 (i.e., the inner loop) in which a set of simulation designs (i.e., microstructure designs to be simulated) are determined. The set of simulation designs determined by the first step 360 are processed in a second step 362, which uses the simulator 114 to physically simulate each simulation design to determine simulated measurements (e.g., toughness and strength measurements) for that design. A third step 364 selects a subset of the simulation designs) referred to as “fabrication designs” based on the simulated measurements. In some examples, the third step 364 selects the subset of simulation designs such that the selected designs are on the Pareto front of the simulator.

In a fourth step 366, the fabrication designs selected by the third step are fabricated to yield physical samples for testing. A fifth step 368 tests the physical samples to obtain physical measurements of the qualities (e.g., toughness and strength) for each of the physical samples. A sixth step 370 updates the configurable parameters of the simulator based on the physical measurements obtained in the fifth step 368. The first through sixth steps are repeated to improve the simulator's performance.

In a seventh step 372, a subset of the fabrication designs referred to as the output designs is chosen as fabrication designs that form a Pareto front based on the measured properties. Finally, in an eighth step 374, given desired qualities of a design (e.g., toughness and strength), the system chooses one of the output designs that best achieves those desired qualities.

### 2.3.2 Inner Loop

Referring to FIG. 4, the inner loop 108 (also referred to as the first step 360 in FIG. 3) repeatedly performs a number of steps including a first step 476 a set of designs are simulated to generate simulated qualities. In a second step 478, configurable parameters of a quality predictor (e.g., a neural network) are updated to match the simulator as currently configured based on the set of simulated designs and corresponding simulated qualities. In a third step 480, a set of prediction designs is generated (e.g., using an evolutionary strategy). In a fourth step 482, for each prediction design, the predictor 116 is used to predict qualities for the predicted design. In a fifth step 484, a subset of the prediction designs is selected based on the predicted qualities, yielding a set of simulated designs. While the inner loop 108 is repeatedly performing the steps, a sixth step 486 provides the set of simulated designs for use in the next iteration of the inner loop. When the inner loop 108 finishes repeatedly performing the steps, the sixth step 486 provides the simulated designs for use by the outer loop 110.

### 3 Family Identification

In some examples, instead of implementing handcrafted or bioinspired toughening mechanisms to fabricate synthetic composites, the system described above facilitates automatic discovery of Pareto-optimal designs even without any prior knowledge. To that end, it is noted that that, in some examples, microstructure designs near the experimental Pareto front can be clustered into four major families, where designs in the same family are structurally similar. The microstructure families allow for extracting and interpreting toughening mechanisms by groups rather than individual designs. Specimens from the different microstructure families can be analyzed to identify well-known mechanisms of toughness enhancement, such as bridging, deflection, and branching. These mechanisms resist crack growth and avoid the formation of clean cleavage like homogeneous composites. Their prominence varies depending on the distribution of soft material.

For example, after the nested-loop pipeline terminates, eleven microstructure designs with near-optimal trade-offs between experimental Young's modulus and toughness are categorized into four families. These microstructure designs are referred to as seed microstructures. The seed microstructures are used to generate more pattern variations in each family and verify that the similarity in mechanical performance is preserved. This procedure breaks down into the following steps. To start, a family-specific simulator was obtained in each family from system identification on all near-Pareto-optimal microstructures. In this case, the seed microstructures were assigned with large identical weights, while others outside the family were assigned with small identical weights for regularization purposes. Such family-specific simulators have much lower prediction error on the seed microstructures in the family compared to the global simulator in Round 4. Then, based on simulation results from the family-specific simulators, a dense evolutionary sampling algorithm was run around seed microstructures to generate a local gamut for each family. The sampling algorithm is akin to the modified NSGA-II algorithm but limits the mutated patterns within a maximum of 16-pixel difference from seed microstructures. There is neither tournament selection of parents nor competition among the population, hence the target is simply to generate a gamut as dense as possible. Lastly, three near-Pareto-optimal microstructures were chosen from the resulting local gamut for physical validation, whose physical measurements were demonstrated to be comparable to seed microstructures. Therefore, it was confirmed that the discovered families contain microstructures with similar patterns and mechanical performance.

To visualize the pattern variation in each microstructure family, each family was divided into subfamilies by extracting microstructures within a 16-pixel radius from each seed microstructure, allowing any microstructure to occur in multiple subfamilies. For every subfamily, a 2D embedding space was computed for all microstructure patterns using Isomap. The 1st Wasserstein distance, i.e. the earth mover's distance (EMD), was used as the distance metric between microstructure patterns instead of the Euclidean distance, since EMD takes into account pixel distributions in microstructure patterns and better reflects differences in geometric shapes. Furthermore, an interpolation model was built for neighboring microstructures in the Isomap embedding space to generate more microstructures that might be missing in the dense sampling. The interpolation method is based on Wasserstein barycenters from optimal transport theory, which has been successfully demonstrated as a robust, intuitive interpolation scheme among voxelized shapes. In this way, around 5% more microstructures patterns are generated in each subfamily on average and can be used to refine the Isomap embedding spaces.

The identification of microstructure families simplifies the analysis of intrinsic toughening mechanisms leading to near-optimal trade-offs between Young's modulus and toughness. As microstructures have similar patterns and performance in each family, they typically share common structural features that enhance fracture resistance. Thus, video recordings of seed microstructures and validation microstructures were used in each family to observe and interpret several predominant toughening mechanisms. For each microstructure, the simulation video produced by family-specific simulators was validated against actual footage from mechanical testing to verify that the mechanisms are properly captured in simulation.

### 4 Alternatives and Implementations

In general, other types of materials and more than two materials may be used to form the microstructured composites. Furthermore, other types of quality measures (beyond toughness and strength) may be optimized.

In experiments performed with the techniques described above, a Stratasys Object 260 Connex multi-material 3D printer has been used. Other jetted additive multi-material fabrication systems can also be used. Furthermore, the techniques are generally agnostic to the class of 3D printing technologies that can be used, including but not limited to including direct ink writing (DIW), fused deposition modeling (FDM), material jetting (MJ), stereolithography (SLA), and digital light processing (DLP).

In examples described above, the approach to searching for candidate prediction designs using a prediction model makes use of an evolutionary algorithm, for example, a genetic algorithm, to search over and sample a combinatorial space of designs. Yet other approaches to generating candidates may other techniques for combinatorial search, such as machine learning based approaches.

While examples described above specify designs according to a material selection for a predefined set of regions, alternative specifications may be used. For example, rather than using a single material in each region, a continuous choice of mixtures (e.g., volumetric ratios) of materials may be selected for each region, thereby replacing the combinatorial search for candidates to a continuous space search. In yet other examples, the designs may be specified by parameters of a spatial random process (e.g., Markov Random Field), and specific designs are random draws of designs according to the random process, and then the search for candidates may take the form of a search for process parameters that yield designs that are on the Pareto boundary.

Alternative approaches that use both a physical model and a neural network include use of a neural network in a reinforcement learning approach, in which the neural network implements a value function for evaluating designs (or sets of designs) or a policy for proposing designs and the physical model is used, for example, in estimating the parameters of such a model. For example, a Dyna or Dyna-Q reinforcement learning approach may be used. In such approaches, the neural network may be improved with both real and simulated “experience”, and the physical model may be improved with real experience (i.e., physically fabricated samples).

Implementations of steps described above may use computer instructions stored on non-transitory machine-readable media for causing a processor to perform the steps. Such processors may be general-purpose processors (e.g., central processing units, CPUs), or special-purpose processors (e.g., graphics processing units (GPUs), tensor processors (TPs) and the like). More generally, the steps may be implemented by circuitry embodying generalor special-purpose processors, or application-specific circuitry (e.g., ASICs).

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for designing a structural combination of a plurality of materials, the method comprising:
determining, using a physical simulator, simulated measurement data for a first plurality of simulation designs, each simulation design characterizing a structural combination of a plurality of materials, the simulated measurement data for each simulation design providing a simulation of physical qualities of said design;
selecting a subset of the simulation designs based on the simulated measurement data for said simulation designs to yield a set of fabrications designs;
providing the set of fabrication designs for fabrication of a set respective physical samples;
receiving a set of physical measurements for the set of physical samples, each physical measurement for a physical sample providing measurements a plurality of physical qualities of the sample; and
reconfiguring the physical simulator using a set of fabrication designs in association with respective physical measurements of physical samples fabricated according to the fabrication designs.

2. The method of claim 1, wherein selecting the subset of the simulation designs to yield the fabrication designs includes excluding at least one simulation design that is dominated in simulation by at least one other simulation design in the plurality of simulation designs, where a first simulation design is dominated in simulation by a second simulated design when all simulated physical qualities of the first simulated design are worse than the corresponding simulated the physical qualities of the second simulated design;

3. The method of claim 2, wherein the output plurality of designs includes only designs that are not dominated in physical measurement by any other design in the plurality of output designs, where a first design is dominated in physical measurement by a second design when all measured physical qualities of the plurality of physical qualities of the first design are worse than the corresponding measured the physical qualities of the second design.

4. The method of claim 1, further comprising determining a plurality of prediction designs, and predicting measurement data for each of the prediction designs.

5. The method of claim 4, wherein predicting measurement data for a prediction design comprises using a neural network to process the prediction design to yield predicted measurement data.

6. The method of claim 4, wherein determining the plurality of prediction designs comprises using an evolutionary procedure to iteratively generate said designs.

7. The method of claim 5, wherein using the neural network comprises using a convolutional neural network to process a spatial specification of material of the design to yield the predicted measurement data.

8. The method of 4, further comprising selecting a subset of the prediction designs based on the predicted measurement data for said prediction designs to yield a set of simulation designs.

9. The method of claim 8 wherein selecting the subset of the prediction designs based on the predicted measurement data includes excluding at least one prediction design that is dominated in prediction by at least one other prediction design in the plurality of prediction designs, where a prediction design is dominated in prediction by a second prediction design when all predicted values of the physical qualities of the first prediction design are worse than the corresponding predicted physical qualities of the second prediction.

10. The method of claim 1, wherein each design comprises a spatial array of regions and identification of respective materials in each of the regions of the array.

11. The method of claim 1, wherein determining the simulated measurement data includes performing a finite-element simulation parameterized by physical parameters of the materials.

12. The method of claim 11, wherein the physical parameters include at least one of Young's modulus and Poisson's ratio.

13. The method of claim 1 repeated a plurality of times.

14. The method of claim 4, in which the steps of claim 4 are repeated a plurality of times for each repetition of the steps of claim 1.

15. The method of claim 1 further comprising, determine an output plurality of designs specifying structural combinations of the plurality of materials.

16. The method of claim 15, wherein the plurality of output designs includes only designs that are not dominated in physical measurement by another design of the plurality of output designs.

17. The method of claim 15, wherein the plurality of output designs includes only designs that are not dominated in simulated measurement by another design of the plurality of output designs.

18. The method of claim 1, further comprising:
fabricating the set of fabrication designs yielding the set respective physical samples; and
measuring the set of physical samples to yield the physical measurements for the physical samples.

19. A system configured to perform steps comprising:
determining, using a physical simulator, simulated measurement data for a first plurality of simulation designs, each simulation design characterizing a structural combination of a plurality of materials, the simulated measurement data for each simulation design providing a simulation of physical qualities of said design;
selecting a subset of the simulation designs based on the simulated measurement data for said simulation designs to yield a set of fabrications designs;
providing the set of fabrication designs for fabrication of a set respective physical samples;
receiving a set of physical measurements for the set of physical samples, each physical measurement for a physical sample providing measurements a plurality of physical qualities of the sample; and
reconfiguring the physical simulator using a set of fabrication designs in association with respective physical measurements of physical samples fabricated according to the fabrication designs.

20. A non-transitory machine-readable medium comprising instructions stored thereon, the instructions when executed by a processor cause the processor to perform steps comprising:
determining, using a physical simulator, simulated measurement data for a first plurality of simulation designs, each simulation design characterizing a structural combination of a plurality of materials, the simulated measurement data for each simulation design providing a simulation of physical qualities of said design;
selecting a subset of the simulation designs based on the simulated measurement data for said simulation designs to yield a set of fabrications designs;
providing the set of fabrication designs for fabrication of a set respective physical samples;
receiving a set of physical measurements for the set of physical samples, each physical measurement for a physical sample providing measurements a plurality of physical qualities of the sample; and
reconfiguring the physical simulator using a set of fabrication designs in association with respective physical measurements of physical samples fabricated according to the fabrication designs.
